(19) United States
(12) Patent Application Publication
(10) Pub. No.: US 2020/0400300 A1
(43) Pub. Date: Dec. 24, 2020

(54) AIDING DEVICE FOR LAMP HEAT DISSIPATION

(71) Applicant: Xiamen PVTECH Co., Ltd., Xiamen (CN)

(72) Inventors: FUXING LU, Xiamen (CN); XIAOPING LAN, Xiamen (CN)

(21) Appl. No.: 16/592,777

(22) Filed: Oct. 4, 2019

(30) Foreign Application Priority Data
Jun. 19, 2019 (CN) 201910529826.X

(51) Int. Cl. F21V 29/73; F21V 29/507

(52) U.S. Cl. CPC F21V 29/73; F21V 29/89; F21V 29/507

(57) ABSTRACT

An aiding device for lamp heat dissipation facilitates the heat dissipation of a lamp. A portion of the lamp has an engaging portion. The aiding device includes an engaging groove, and the engaging groove of the aiding device is adapted to be engaged with the engaging portion of the lamp, so that the aiding device is assembled on the lamp. Accordingly, the temperatures of the power module, the electronic components, or the light emitting components can be reduced through heat dissipation, thereby extending the lifetime of the lamp.

### BACKGROUND OF THE INVENTION

### 1. Field of the Invention

The present invention relates to an aid component for lamp, in particular to an aiding device for lamp heat dissipation.

### 2. Description of the Prior Art

Lighting apparatuses become essential parts in daily lives. Lighting apparatuses may be applicable to different fields, for example, may be household lights, commercial lights, industrial lights, and traffic lights.

As mentioned, lighting apparatuses are applicable to different application fields; moreover, the lights can be further divided into different types. The technologies of the lighting apparatuses are well-developed. Regarding to the household applications, different types of lamps are developed for meeting the users' requirements on different aspects.

In general, to solve the problem for lamp heat dissipation, the size of the lamp socket is increased to increase the heat dissipation area for the lamp; however, under such configuration, the appearance of the lamp is not aesthetical and the length of the lighting surface of the lamp is reduced. Therefore, it is an issue to design an aiding device for lamp heat dissipation, allowing the lamp to have a great heat dissipation property.

### SUMMARY OF THE INVENTION

In view of these, an aiding device for lamp heat dissipation is provided. The aiding device facilitates the heat dissipation of a lamp. A portion of the lamp has an engaging portion. The aiding device comprises an engaging groove, and the engaging groove of the aiding device is adapted to be engaged with the engaging portion of the lamp, so that the aiding device is assembled on the lamp.

In some embodiments, the aiding device comprises a heat dissipation tubular body and at least one extension sheet, the at least one extension sheet is located at one side of the heat dissipation tubular body, and the heat dissipation tubular body is recessed to form the engaging groove.

In some embodiments, the aiding device is a one-piece structure.

In some embodiments, the aiding device is made of metal or metal alloy.

In some embodiments, when the engaging groove is engaged with the engaging portion of the lamp, the engaging groove is adjacent to a tube opening of the lamp.

In some embodiments, the aiding device comprises a plurality of extension sheets respectively located at two sides of the heat dissipation tubular body, and the extensions sheets are arranged in a mirror symmetry by taking the heat dissipation tubular body as a symmetry center.

In some embodiments, the at least one extension sheet is bendable or foldable.

In some embodiments, the at least one extension sheet is bent to form at least one passage.

In some embodiments, the aiding device comprises a plurality of extension sheets, adjacent two extension sheets of the extension sheets are connected with each other, and a hole is at a connection portion between the adjacent two extension sheets.

In some embodiments, the extension sheets are further connected to a bottom portion of the heat dissipation tubular body.

Accordingly, the aiding device according to embodiments of the present invention can be applied to reduce the temperatures of the power module, the electronic components, or the light emitting components, through heat dissipation, thereby extending the lifetime of the lamp. Moreover, in the case where the lamp is an LED lamp, the power module is received in the lamp socket, and thermal conductive glues are applied to the lamp socket to reduce the temperature of the power module, thereby extending the lifetime of the LED lamp.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exploded view of an aiding device for lamp heat dissipation according to a first embodiment of the present invention;

FIG. 2 illustrates a perspective view of the aiding device of the first embodiment;

FIG. 3 illustrates a schematic operational view of the aiding device of the first embodiment;

FIG. 4 illustrates another schematic operational view of the aiding device of the first embodiment;

FIG. 5 illustrates a perspective view of an aiding device for lamp heat dissipation according to a second embodiment of the present invention;

FIG. 6 illustrates a perspective view of an aiding device for lamp heat dissipation according to a third embodiment of the present invention;

FIG. 7 illustrates a perspective view of an aiding device for lamp heat dissipation according to a fourth embodiment of the present invention; and

FIG. 8 illustrates a perspective view of an aiding device for lamp heat dissipation according to a fifth embodiment of the present invention.

### DETAILED DESCRIPTION

The detailed features and the advantages of the present invention will become more obvious from the following description for any person having ordinary skills in the art to carry out the claimed invention. Further, based on the disclosure, the claims, and the accompanying drawings, any person having ordinary skills in the art can understand the purpose and the advantages of the present invention easily.

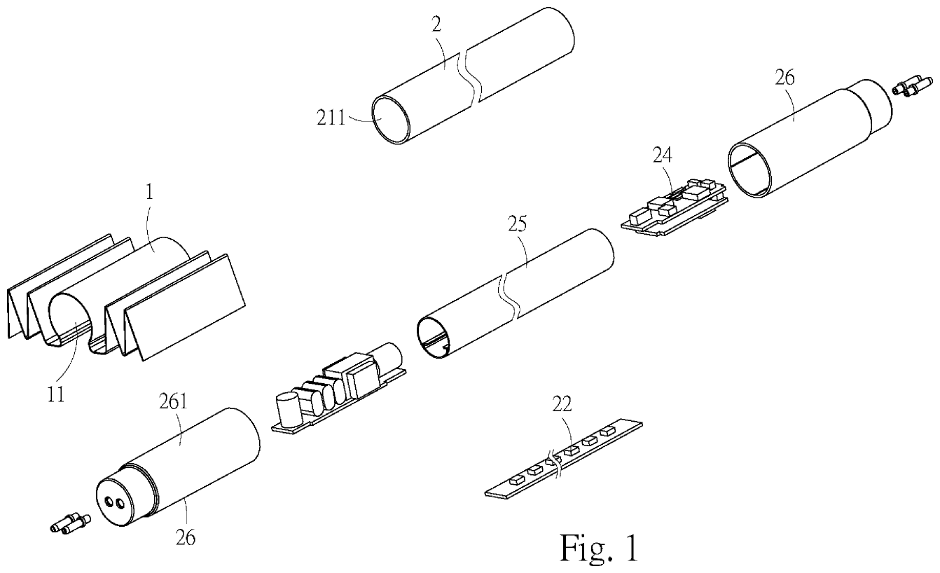

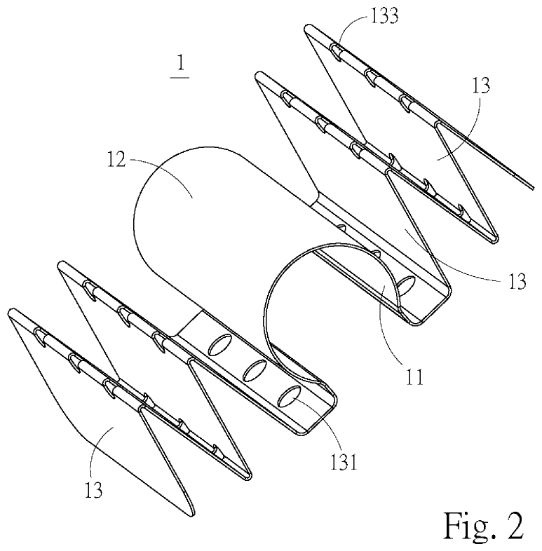

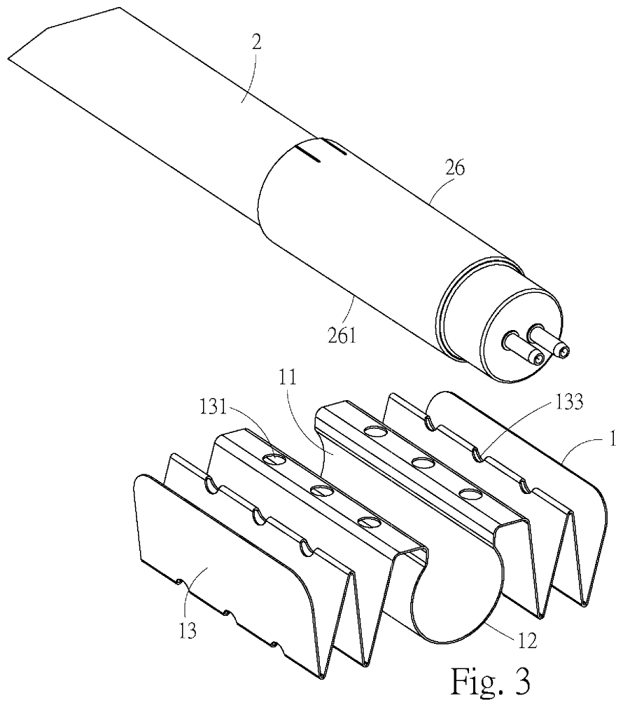

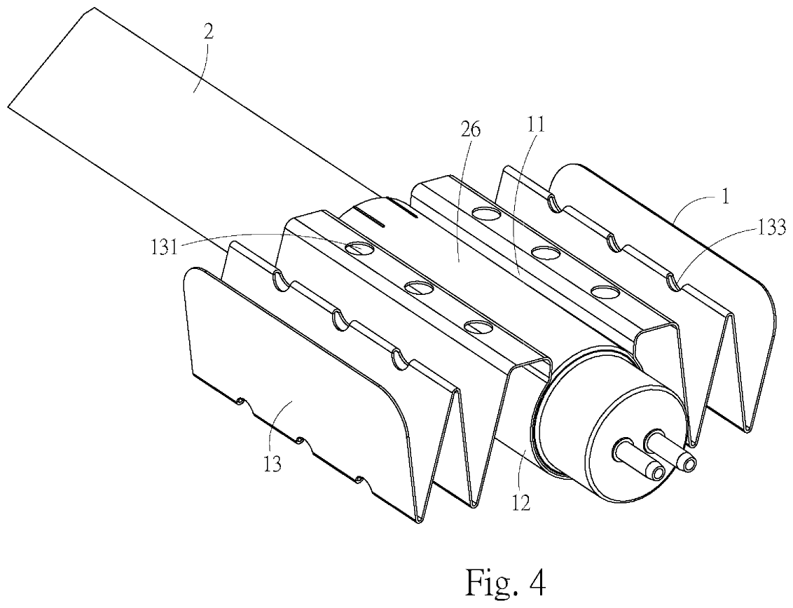

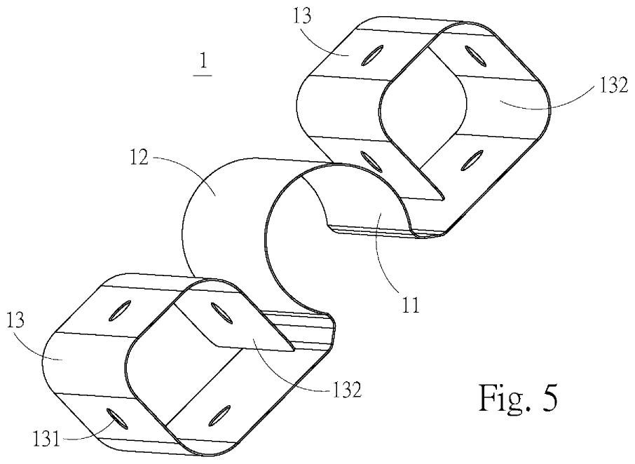

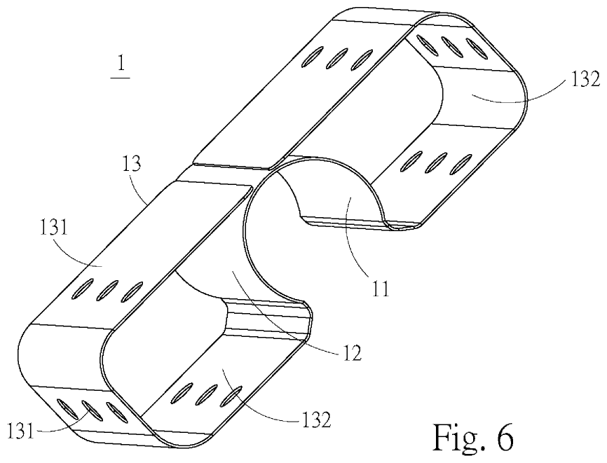

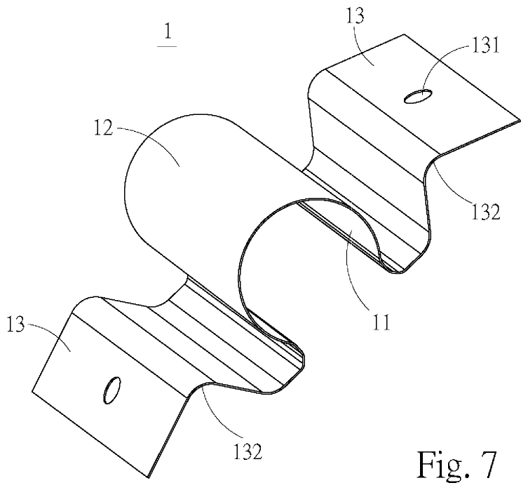

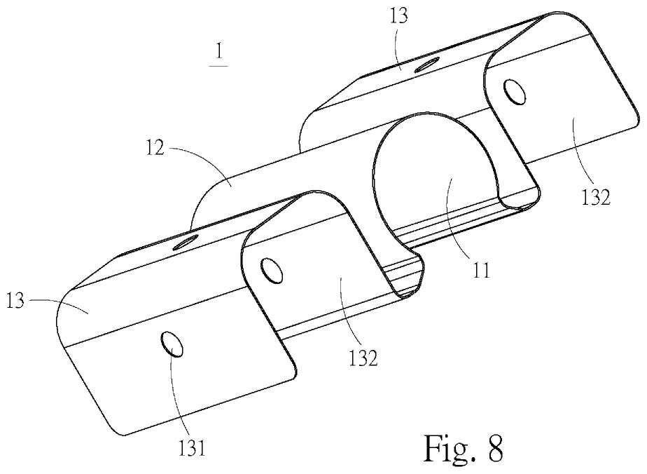

Please refer to FIGS. 1 to 8. FIG. 1 illustrates an exploded view of an aiding device 1 for lamp heat dissipation according to a first embodiment of the present invention. FIG. 2 illustrates a perspective view of the aiding device 1 of the first embodiment. FIG. 3 illustrates a schematic operational view of the aiding device 1 of the first embodiment. FIG. 4 illustrates another schematic operational view of the aiding device 1 of the first embodiment. FIG. 5 illustrates a perspective view of an aiding device 1 for lamp heat dissipation according to a second embodiment of the present invention. FIG. 6 illustrates a perspective view of an aiding device 1 for lamp heat dissipation according to a third embodiment of the present invention. FIG. 7 illustrates a perspective view of an aiding device 1 for lamp heat dissipation according to a fourth embodiment of the present invention. FIG. 8 illustrates a perspective view of an aiding device 1 for lamp heat dissipation according to a fifth embodiment of the present invention.

Please refer to FIGS. 1 to 4. The aiding device 1 is adapted to facilitate the heat dissipation for a lamp. A portion of the lamp has an engaging portion 261. In this embodiment, the lamp comprises a lamp tube 21, a plastic tubular member 25, a light bar 22, a first power module 23, a second power module 24, and a lamp socket 26. The engaging portion 261 is located on the lamp socket 26; but embodiments are not limited thereto, the engaging portion 261 may be located on the lamp tube 21. The aiding device 1 comprises an engaging groove 11, and the engaging groove 11 of the aiding device 1 is engaged with the engaging portion 261 of the lamp, so that the aiding device 1 is assembled on the lamp.

It is understood that, in this embodiment, the number of the aiding device 1 is one; namely, one aiding device 1 is used for facilitating the heat dissipation for one lamp; but embodiments are not limited thereto; in some embodiments, two or more aiding devices 1 may be used for facilitating the heat dissipation for one lamp.

Please refer to FIGS. 1 to 8. The aiding device 1 comprises a heat dissipation tubular body 12 and extension sheet(s) 13. The number of the extension sheet (s) 13 may be one or more than one; namely, in this embodiment, the aiding device 1 comprises at least one extension sheet 13, and the at least one extension sheet 13 is located at one side of the heat dissipation tubular body 12. In some embodiments where the aiding device 1 comprises several extension sheets 13, the extension sheets 13 are located at two sides of the heat dissipation tubular body 12, and the heat dissipation tubular body 12 is recessed to form the engaging groove 11.

In some embodiments, the aiding device 1 is a one-piece structure, such that the manufacturing steps for the aiding device 1 can be reduced, thereby reducing the manufacturing cost for the aiding device 1.

In some embodiments, the aiding device 1 is made of metal of metal alloy. For example, the aiding device 1 may be made of aluminum or phosphor bronze. Phosphor bronze is a material with flexibility and extensibility. Therefore, according to users' requirements, in the case where the aiding device is made of phosphor bronze, the size and the shape of the engaging groove 11 can be adjusted by the user to correspond to lamps with different tube sizes and shapes, so that the aiding device 1 can be provided for facilitating the heat dissipation of the lamp.

Please refer to FIGS. 1 to 4. Because the engaging portion 261 is on the lamp socket 26, the engaging groove 11 is adjacent to a tube opening 211 of the lamp when the engaging groove 11 is engaged with the engaging portion 261. As mentioned, the position of the engaging portion 261 is not limited; the engaging portion 261 may be located at the lamp tube 22 of the lamp.

Please refer to FIGS. 1 to 8. In some embodiments, the extension sheets 13 are respectively located at two sides of the heat dissipation tubular body 12, and the extension sheets 13 are arranged in a mirror symmetry by taking the heat dissipation tubular body 12 as a symmetry center.

Furthermore, in some embodiments, the extension sheets 13 comprise at least one ventilation hole 131.

The shape of the extension sheet 13 is not limited. The extension sheet 13 is bendable or foldable to format least one passage 132. In the embodiments shown in FIGS. 1 to 8, the number of the passage 132 outside the lamp may be one, two, or more. In FIGS. 1 to 4, the extension sheet 13 is bent to form two passages 132, while in FIGS. 5 to 8, the extension sheet 13 is bent to form one passage 132.

On the other hand, as shown in FIG. 2, in this embodiment, adjacent two extension sheets 13 of the extension sheets 13 are connected with each other, and a hole 133 is at a connection portion between the adjacent two extension sheets 13. Conversely, as shown in FIG. 6, in this embodiment, the extension sheets 13 are further connected to a bottom portion of the heat dissipation tubular body 12. In other words, the structure of the extension sheet 13 is not limited; the extension sheet 13 may be bent or folded, according to different users' requirements.

Accordingly, the aiding device according to embodiments of the present invention can be applied to reduce the temperatures of the power module, the electronic components, or the light emitting components, through heat dissipation, thereby extending the lifetime of the lamp. Moreover, in the case where the lamp is an LED lamp, the power module is received in the lamp socket, and thermal conductive glues are applied to the lamp socket to reduce the temperature of the power module, thereby extending the lifetime of the LED lamp.

Furthermore, in some embodiments, the aiding device has a wide applicability and can be applied to lamps or lamp tube received with power module(s) indifferent types and different tube sizes. The user can adjust the shape of the aiding device, for instance, the size of the engaging groove, the shape of the extension sheet, and the structure of the extension sheet, according to different requirements.

Although particular embodiments of the invention have been described in detail for purposes of illustration, various modifications and enhancements may be made without departing from the spirit and scope of the invention. Accordingly, the invention is not to be limited except as by the appended claims.

Those skilled in the art will readily observe that numerous modifications and alterations of the device and method may be made while retaining the teachings of the invention. Accordingly, the above disclosure should be construed as limited only by the metes and bounds of the appended claims.

1. An aiding device for lamp heat dissipation adapted to facilitate the heat dissipation of a lamp, wherein a portion of a lamp has an engaging portion; wherein the aiding device comprises a heat dissipation tubular body and at least one extension sheet, the at least one extension sheet is extended traversely outward and attached to one side of the heat dissipation tubular body, and the heat dissipation tubular body is recessed to form an engaging groove to be engaged with the engaging portion of the lamp, so that the aiding device is assembled on the lamp.

2. (canceled)

3. The aiding device according to claim 1, wherein the aiding device is a one-piece structure.

4. The aiding device according to claim 1, wherein the aiding device is made of metal or metal alloy.

5. The aiding device according to claim 1, wherein when the engaging groove is engaged with the engaging portion of the lamp, the engaging groove is adjacent to a tube opening of the lamp.

6. The aiding device according to claim 1, wherein the aiding device comprises a plurality of extension sheets respectively located at two sides of the heat dissipation tubular body, and the extensions sheets are arranged in a mirror symmetry by taking the heat dissipation tubular body as a symmetry center.

7. The aiding device according to claim 1, wherein the at least one extension sheet is bendable or foldable.

8. The aiding device according to claim 1, wherein the at least one extension sheet is bent to form at least one passage.

9. The aiding device according to claim 1, wherein the aiding device comprises a plurality of extension sheets, adjacent two extension sheets of the extension sheets are connected with each other, and a hole is at a connection portion between the adjacent two extension sheets.

10. The aiding device according to claim 8, wherein the extension sheets are further connected to a bottom portion of the heat dissipation tubular body.
